(19) United States
(12) Patent Application Publication
(10) Pub. No.: US 2007/0166443 A1
(43) Pub. Date: Jul. 19, 2007

(54) APPARATUS FOR USE IN COOKING FOOD PATTIES

(76) Inventor: Bruce Mitchell, Calgary (CA)

Correspondence Address: DENNIS T. GRIGGS, 17950 PRESTON ROAD, SUITE 1000, DALLAS, TX, 75252, US

(21) Appl. No.: 11/621,225

(22) Filed: Jan. 9, 2007

(30) Foreign Application Priority Data
Jan. 11, 2006 (CA) 2,532,598

(51) Int. Cl. A23C 3/00

(52) U.S. Cl. 426/523

(57) ABSTRACT

An apparatus for use in cooking food includes a hollow tube for receiving food to be cooked and spacer members disposed in the hollow tube. The food and spacer members are alternately placed into the hollow tube, in a similar orientation as coins are arranged in a roll of coins. The spacer members facilitate the conduction of heat to the surfaces of the food. Each item of food has a spacer member or a lid member abutting to it to receive heat from the abutting spacer member and/or lid member as well as from the wall of the hollow tube. The hollow tube can also receive one or more lids. When in use, the hollow tube is placed directly on a cooking surface or is attached to a rotisserie to cook the food. The orientation of the food when in the apparatus reduces the amount of cooking surface required for cooking.

### BACKGROUND OF THE INVENTION

1. Field of the Invention

The present invention is generally related to food cooking apparatus, and in particular to an apparatus for use in cooking food in a frying pan or on a grill, barbeque or the like.

2. Description of the Related Art

Preparing food into patties is an effective means of preparing food for cooking. Food patties are often uniform in shape and often disk shaped. They cook quickly due their relatively large ratio of surface area to volume. As well, food patties fit into a bun for easy handling and consumption. The main ingredient of food patties is often ground meat such as beef, pork, poultry or fish. There are a number of vegetarian forms of these food patties that often include as a main ingredient grains, seeds, rice, soy or mushrooms.

Conventionally, food patties are cooked by placing them directly onto a cooking surface of a frying pan, grill or barbeque. The cooking unit of a grill or barbeque is often made of a metal, such as iron or steel, which is compatible for use with food and which resists deformation and deterioration from being exposed to heat and which conducts heat, when heated by a heat source, typically located below the cooking unit, to the cooking surface. Some cooking units may have one or more heating elements incorporated directly into the unit.

Some conventional cooking units may or may not have perforations. In the case of a non-perforated cooking unit, the heat from the heat source heats the cooking unit that, in turn, heats the food patty on the cooking surface. In the case of a perforated cooking unit, not only does the heat from the heat source heat the cooking unit which in turn heats the food patty, the heat source also heats the food patty directly, as heat passes through the perforations of the cooking unit to act directly on the food patty. In the case of a heat source that also produces flames, the flames can pass through the perforations of the cooking unit and act directly on the food patty, as well.

However, the foregoing cooking method requires a relatively large cooking surface for each food patty. For example, if each food patty is 10 centimeters in diameter, four food patties will require a cooking surface of at least 314 square centimeters.

Potentially the food patty ingredients could be formed into a different shape in order to reduce the amount of cooking surface required. For example, rather than being formed into the shape of a disk, the ingredients could be formed into a cube. This would increase the ratio of volume of food ingredient for any give area of cooking surface. However, one of the advantages of the disk shape of a food patty is that it is easier to eat in that form. Further, another advantage of the disk shape of a food patty is that every part of the food patty is within a relatively short distance from the cooking surface and, therefore, each part of the food patty heats up to the required cooking temperature in a fairly short period of time. The farther away any part of the food item is from the cooking surface the longer it will take for that part to reach cooking temperature.

Therefore, for example, if the food ingredients are formed into the shape of a cube, either the temperature of the cooking surface would have to be increased or the time required to cook would have to be increased in order to ensure that all of the food ingredients are thoroughly cooked. By increasing the temperature of the cooking surface there will be an increase in the disparity between the temperatures that various parts of the food is subject. In this case the outer surfaces will be exposed to a higher temperature than the innermost part of the food cube. This is often not desirable as it may lead to the burning or overcooking of the outer parts of the food, while leaving the inner portions undercooked. Increasing the time required to cook the food is often not desirable.

It is, therefore, desirable to provide an apparatus for cooking food that overcomes the foregoing limitations.

### BRIEF SUMMARY OF THE INVENTION

An apparatus for use in cooking food is provided. In one embodiment, the cooking apparatus comprises spacer members for propagating heat to food formed into patties, and a hollow tube for receiving food patties and spacer members, whereby the food patties and spacer members can be alternately placed into the hollow tube, in a similar orientation as coins are arranged in a roll of coins, until the hollow tube is either full or the desired number of food patties to be cooked have been placed in the hollow tube and the hollow tube is then placed directly on a cooking surface or is attached to a rotisserie to cook the food patties.

In another embodiment, food not formed into patties can be cooked in the cooking apparatus fo the present invention. Examples of types of such unformed food that can be cooked in the apparatus can include whole game hens, poultry parts, beef or pork roasts or non-meat foods such as vegetables, soy-based food products and the like. It will be understood by a person skilled in the art that various types of food in various configurations can be cooked in the apparatus or that different types of food can be cooked in the apparatus that is fitted with spacers or spacing members that are used to separate different types of food within the cooking apparatus.

In one embodiment, the spacer members is made of two plates of material having substantially the same shape as the cross-section of the hollow tube, but slightly smaller to permit a relatively snug fit inside the hollow tube. In this embodiment the plates are separated by one or more connecting members. In another embodiment, the connecting members include several rods extending longitudinally between the two plates. In yet another embodiment, a band of material is used to join the outer perimeter of each plate. In still another embodiment, the side edges of one or more bands of material are joined to the inner surface of the plates so that the bands of material keep the plates separated.

According to another aspect of the invention, there is provided alignment means to keep the spacer members and the food patties facing in the same direction as the direction of the hollow tube. This alignment means can include the relatively snug fit of the spacer members, which will keep the planar surfaces of the spacer members facing in the same direction as the longitudinal direction of the hollow tube. Since the food patties are sandwiched between two spacer members or a spacer member and a lid, the planar surfaces of the food patties will be kept facing the same direction as well.

In yet another embodiment, the cooking apparatus can be attached to a rotisserie. This is accomplished in a number of ways. In one arrangement, rotisserie attachment rods are permanently attached to the lids or a lid and an end of the cooking apparatus. In another arrangement, the lids or the lid and the end of the apparatus have receiving members for attachably receiving rotisserie rods.

In providing an apparatus for use in cooking food patties described herein, the amount of area of cooking surface required for each food patty is reduced since the food patties are oriented in the apparatus on their edge, even when taking into account the space required for spacer members and lid members.

In addition, the spacer members and lid members facilitate the propagation of heat and flames to the outer surfaces of each food patty that is contacted by the spacer member or lid member. This will reduce the time required to cook the food ingredients in comparison to the situation where the food ingredients are being cooked in a contiguous mass such as a cube.

The cooking apparatus of the present invention provides a means for increasing the number of food patties that can be cooked on a grill for any given area of cooking surface, which will enable food patties to be cooked in circumstances where only a limited cooking area or no cooking surface at all is provided for placement of food patties during cooking. This is accomplished by a hollow tube having a pocket for receiving food to be cooked and at least one spacer member disposed within the pocket of the hollow tube.

### BRIEF DESCRIPTION OF THE SEVERAL VIEWS OF THE DRAWINGS

FIG. 1 is a side perspective view depicting a cooking apparatus in one embodiment.

FIG. 2 is a side perspective view depicting the cooking apparatus of FIG. 1 with lids attached.

FIG. 3 is a perspective view depicting one embodiment of a spacer member for use with the cooking apparatus of FIG. 1.

FIG. 4 is a perspective view depicting a first alternative embodiment of a spacer member for use with the cooking apparatus of FIG. 1.

FIG. 5 is a side perspective view depicting a representative embodiment of the cooking apparatus of FIG. 2 with a section of the hollow tube sidewall cut away to show the orientation of food patties and spacer members when in use.

FIG. 6 is a side perspective view depicting the cooking apparatus of FIG. 2 mounted on a rotisserie bar.

FIG. 7 is a perspective view depicting a second alternate embodiment of a spacer member for use with the cooking apparatus of FIG. 1 in a preassembled state.

FIG. 8 is a perspective view depicting the space member of FIG. 7 in an assembled state.

FIG. 9 is a perspective view depicting a third alternate embodiment of a spacer member for use with the cooking apparatus of FIG. 1 in a preassembled state.

FIG. 10 is a perspective view depicting the space member of FIG. 9 in an assembled state.

FIG. 11 is a perspective exploded view depicting the cooking apparatus of FIG. 1 with an attachment for cooking hot dogs or sausages.

### DETAILED DESCRIPTION OF THE INVENTION

An apparatus for use in cooking food is provided. In one embodiment, the apparatus is configured for cooking food formed into patties. In this embodiment, the food patties are oriented on their edge in relation to the cooking surface and heat source thereby allowing the food patties to be cooked on a smaller cooking surface in comparison to conventional means. Alternatively, the food patties can be cooked in circumstances where there is no cooking surface.

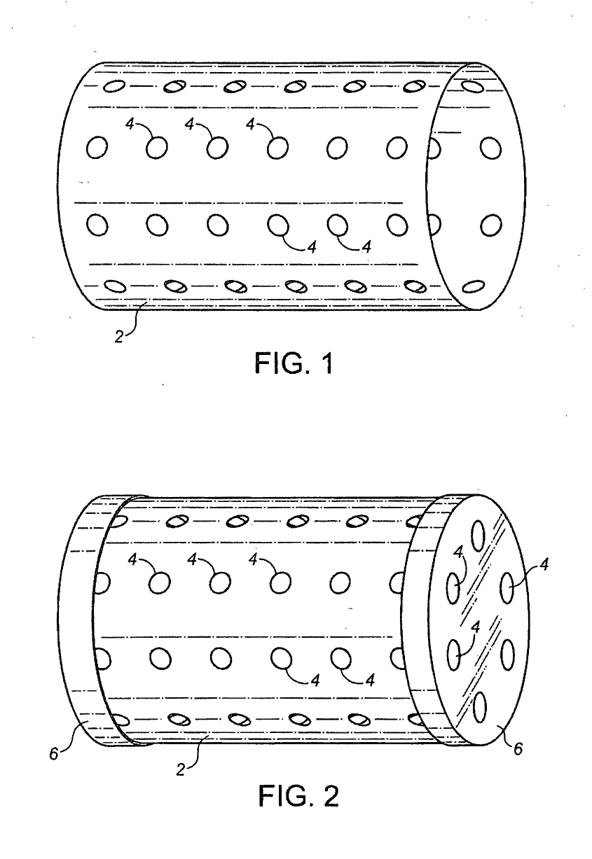

A representative embodiment of the apparatus is shown in FIG. 1. Apparatus 10 comprises of hollow tube 2 having an internal cavity or pocket for receiving one or more food items, for example formed food patties 32 and spacer members 20. The cross-section of the cavity or pocket of the hollow tube 2 in which the spacer members and food items are received is generally in the same shape as the shape delineated by the planar dimension of food patties 32. Food patties 32 are placed in the hollow tube 2 such that the plane of the described planar dimension of food patty 32 is on the same plane as the transverse cross-section of the cavity of hollow tube 2. It should be obvious to a person skilled in the art that food not formed formed patties 32, whole game hens, poultry parts, beef or pork roasts or non-meat foods such as vegetables, soy-based food products and the like can be placed between spacer members 20 and cooked when the apparatus 10 is placed on a cooking surface such as a frying pan, a grill, a barbeque or the like.

FIG. 2 shows hollow cooking tube 2 with lids 6 attached. In one embodiment, lids 6 can be removed to access the contents that are received in the cavity of the cooking tube. In another embodiment, one of the ends of the hollow tube 2 can be closed. In which case, only one lid 6 is needed for use with apparatus 10. Lids 6 can be held in place when attached to the end of the hollow tube 2 by various conventional fastener means, known to those skilled in the art.

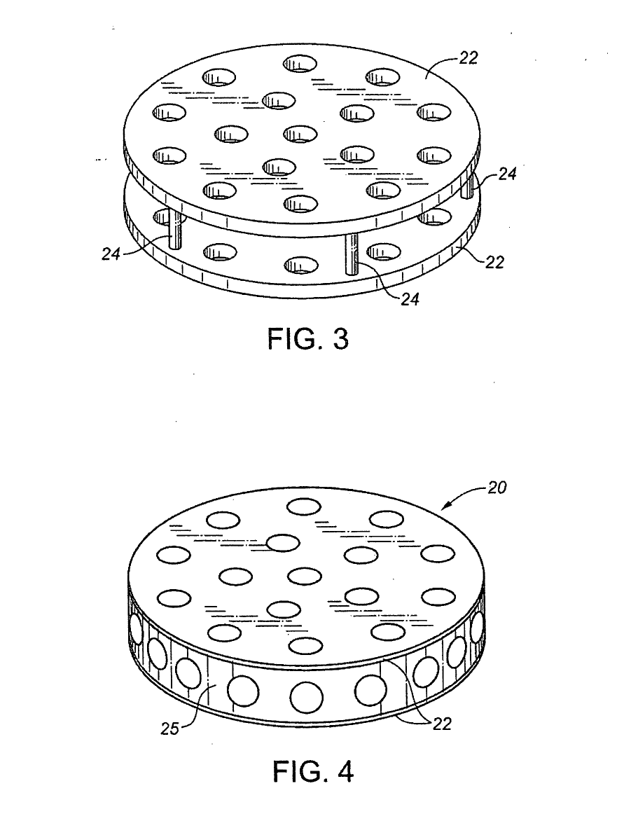

FIG. 3 shows spacer member 20 comprising outer plates 22 and which outer plates 22 are kept a fixed distance apart by means such as connecting members. In the illustrated embodiment, the connecting members are rods 24. Plate members 22 are set at a fixed and uniform distance apart by rods 24. In a representative embodiment, the space between plate members 22 measures between about one millimeters and about 20 millimeters. Other means can be employed to keep the outer plates 22 separated, including conventional means known to those skilled in the art. Examples of such other means are shown in FIGS. 7 through 10.

In one embodiment, the spacer member 20 are formed from spacer preform 40 as shown in FIG. 7. In this embodiment, two outer plates 22 are joined by tab 42. In addition, a plurality of legs 40 are disposed on outer plates 22. In one embodiment, legs 42 can be integral to spacer preform 40 and are formed by stamping spacer preform 40 as well known to those skilled in the art. In this illustrated embodiment, outer plates 22 are folded towards each other until legs 44 of each outer plate 22 are touching each other as indicated by reference numeral 46 shown in FIG. 8. Legs 44 can be secured to each other by spot-welding or by any other suitable means. Accordingly, the means to keep outer plates 22 separated include tab 42 and legs 44.

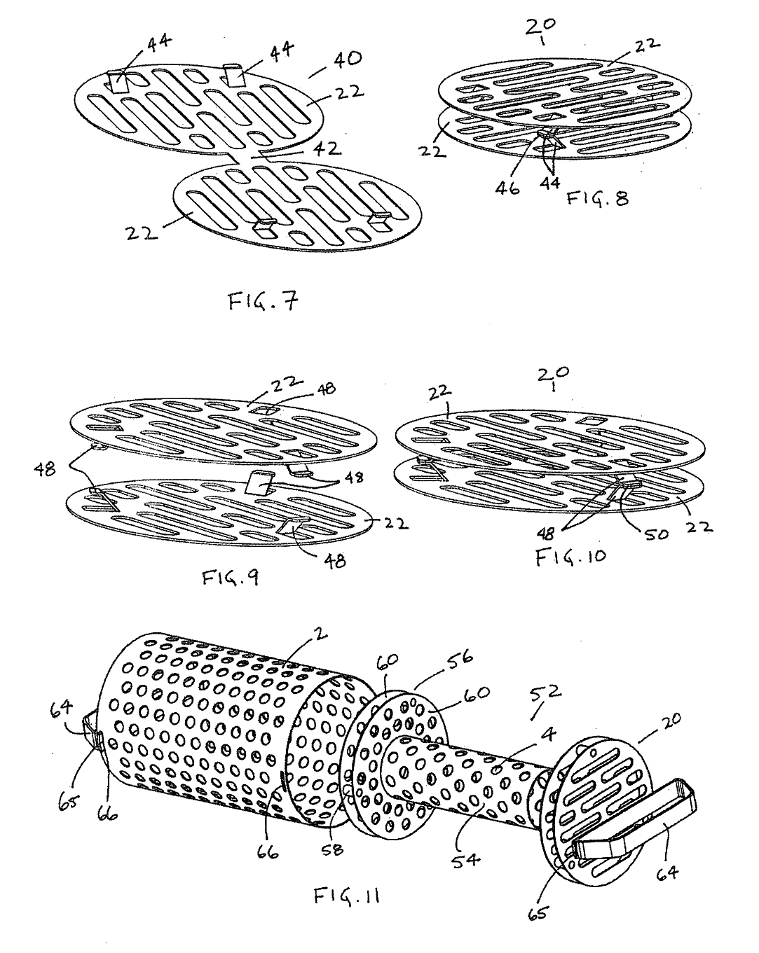

In another embodiment as shown in FIGS. 9 and 10, the means to separate outer plates 22 can include legs 48 disposed on each of outer plates 22. In one embodiment, legs 48 can be integral to outer plates 22 and can be formed by stamping outer plates 22. Referring to FIG. 10, two outer plates 22 are brought together until legs 48 are touching each other as indicated by reference numeral 50. Legs 48 can be attached to one another by spot-welding or by any other suitable means.

Referring to the illustrated embodiment shown in FIG. 3, heated air is able to move between outer plates 22 of spacer members 20 to heat the outer surface of food patty 32 by heating outer plates 22. In another embodiment, apertures 4 in outer plates 22 can facilitate the heating of the outer surface of food patty 32. In a further embodiment, spacer members 20 can be made of a solid mass of a material that conducts heat or, alternatively, can have one or more openings and channels that facilitates the propagation of heat and flame to the surfaces of spacer member 20.

When placed in the hollow tube 2, the plane of the planar dimension of spacer member 20 can be the same as the plane of the transverse cross-section of hollow tube 2. In a representative embodiment, the outline of the planar dimension of spacer members 20 would be the same general shape as the shape of the transverse cross-section of hollow tube 2.

Shown in FIG. 4 is an alternate embodiment of spacer member 20. In this embodiment, band 25 separates plates 22 of spacer member 30. Band 25 may or may not have apertures 4. When band 25 is heated, it heats the air inside spacer member 30 that, in turn, heats outer plates 22 which then heats the outer surface of food patty 32. If band 25 comprises apertures 4, then heat would flow directly through apertures 4.

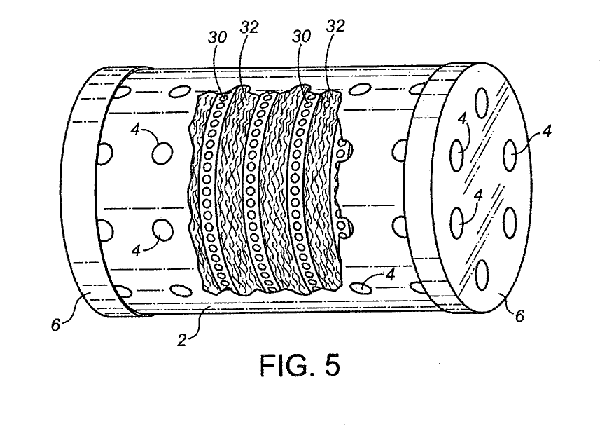

Shown in FIG. 5 is an apparatus for use in cooking food patties 32 with lids 6 and apertures 4. In the illustrated embodiment, food patties 32 are shown abutting spacer members 30. In a representative embodiment, spacer members 30 and the transverse cross-section of hollow tube 2 can be circular in shape. The wall of hollow tube 2 has apertures 4 to permit heat and flame to act directly on spacer members 30 and food patties 32 while apertures 4 are small enough so that the contents of hollow tube 2 would not extend outside hollow tube 2.

The lids 6 are attachable to hollow tube 2. Lids 6 have apertures 4 to permit heat and flame to act directly on the contents closest to the ends of hollow tube 2. Plate members 22 of spacer members 30 may also have apertures 4. In this embodiment, food patties 32 and spacer members 30 are slightly smaller than the size of the transverse cross-section of hollow tube 2 so that they fit snugly into hollow tube 2. This snugness will assist the contents to remain in the preferred orientation in relation to hollow tube 2.

Food patties 32 and spacer members 30 are alternately placed in hollow tube 2 until hollow tube 2 is either full or the desired number of food patties 32 to be cooked have been placed in hollow tube 2. Spacer members 30 and food patties 32 are placed in hollow tube 2 so that the planar surfaces of food patty 32 and the planar surface of adjoining spacer members 30 abut contiguously.

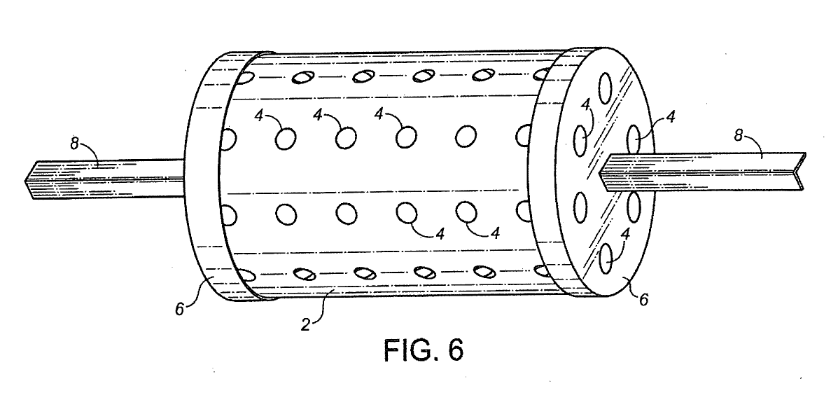

An alternate embodiment of the present invention is shown in FIG. 6. In this embodiment, rotisserie rods 8 are affixed to lids 6. The ends of rotisserie rods 8 not affixed to lids 6 may then be attached to a rotisserie (not shown). As the rotisserie rotates, the apparatus would rotate and the heat would be uniformly spread over the outer surface of hollow tube 2. This facilitates the even cooking of food patties 32. Alternatively, if the apparatus is employed directly on a cooking surface then the apparatus should be rolled at intervals to ensure that the outer surface of hollow tube 2 is evenly heated and this will facilitate the even cooking of food patties 32.

In the embodiments of apparatus 10 presented herein, the hollow tube 2 and spacer members 20 and 30 are made of a food grade structural metal material, such as steel or iron that does not deform or degrade when exposed to heat sources that are used in cooking food. In use, apparatus 10 when filled with food patties is placed on the cooking surface and rotated at intervals to ensure even cooking. In another embodiment, the apparatus 10 can be attached to a rotisserie using rotisserie bars 8 where apparatus 10 can rotate above the cooking surface to ensure even cooking of the food patties.

Referring to FIG. 11, apparatus 10 is shown with cooking attachment 52 that can be used for cooking foods such as hot dogs, sausages and the like. Attachment 52 can comprise of spacer member 56 and tube 54. Spacer member 56 can include two outer plates 60 that are separated by means such as connecting members in a similar fashion as for spacer members 20 as described above. In the illustrated embodiment, outer plates 60 can be separated by rods 58 although other means can be used to separate outer plates 60 as described herein. In this embodiment, tube 54 can extend perpendicular from spacer member 56.

According to one embodiment, tube 54 can be attached to one outer plate 60 by spot-welding or any other suitable means. In another embodiment, outer plates 60 can include an opening through which tube 54 extends such that one end of tube 54 is flush with the outer surface of one outer plate 60. Tube 54 can be secured to spacer member 56 by spot-welding or any other suitable means.

In operation, cooking attachment 52 is inserted into tube 2 thereby forming an annular spacer between tube 54 and the interior surface of tube 2. Food items such as hot dogs, sausages and the like can be placed in this annular space to be cooked in apparatus 10. Spacer member 20 is then inserted into tube 2 to enclose the food. Spacer members 20 and 56 are secured in tube 2 by handles 64. In one embodiment, tube 2 can include slots 66 as illustrated for receiving tabs 65 disposed on handles 64 to secure handles 64 to tube 2. In another embodiment, cooking attachment 56 can include perforations 4 to aid in the distribution of heat within apparatus 10.

Although preferred and alternative embodiments have been shown and described, it will be appreciated by those skilled in the art that various changes and modifications might be made to the disclosed embodiments without departing from the scope of the invention. The terms and expressions used in this specification have been used solely as terms of description and not of limitation. The use of such terms and expressions is not intended to exclude equivalents of the features shown and described or portions thereof. The scope of the invention is defined and limited only by the claims that follow.

I claim:

1. An apparatus for use in cooking food, comprising:
at least one spacer member; and
a tube having an internal cavity adapted for receiving an item of food and the at least one spacer member within the internal cavity of the tube.

2. The apparatus as set forth in claim 1 further comprising means for maintaining the planar orientation of a food item and the planar orientation of the at least one spacer member in substantially the same plane as the plane of a transverse cross-section of the tube.

3. The apparatus as set forth in claim 1 wherein the at least spacer member and the transverse cross-section of the tube have generally the same shape as a food item to be cooked.

4. The apparatus as set forth in claim 1 wherein the transverse cross-section of the tube is substantially circular and the shape of the at least one spacer member is substantially circular.

5. The apparatus as set forth in claim 1 wherein
the tube has a tubular wall forming a boundary of the cavity and the wall is intersected by at least one aperture; and
the dimension of at the least one aperture is limited whereby a food item and the at least one spacer member cannot extend outside the interior of the tube
through the at least one aperture.

6. The apparatus as set forth in claim 1 and wherein the at least one spacer member comprises two planar outer plates and means for keeping the outer plates a fixed distance apart.

7. The apparatus as set forth in claim 6 wherein the fixed distance is in the range of about 1 millimeter to about 20 millimeters.

8. The apparatus as set forth in claim 6 wherein the outer plates are intersected by at least one aperture.

9. The apparatus as set forth in claim 6 wherein the means for keeping the outer plates a fixed distance apart comprises a plurality of rods of extending between the outer plates, with the rods disposed substantially perpendicular to the plane of the outer plates.

10. The apparatus as set forth in claim 1, further comprising a planar end member wherein the end member is permanently affixed to one of the longitudinal ends of the tube whereby the end member closes off the pocket on one end of the tube.

11. The apparatus as set forth in claim 10 wherein the end member is intersected by at least one aperture.

12. The apparatus as set forth in claim 1 further comprising at least one lid member adapted to receivably attach to a longitudinal end of the tube.

13. The apparatus as set forth in claim 12 wherein the at least one lid member is intersected by at least one aperture.

14. The apparatus as set forth in claim 6 wherein the means for keeping the outer plates a fixed distance apart comprises a band of substantially uniform width extending between the outer plates along the circumference of the outer plates.

15. The apparatus as set forth in claim 1 further comprising means for attaching the tube to a rotisserie apparatus, whereby the rotisserie apparatus is adapted to rotate the tube relative to a heat source.

16. An apparatus for use in cooking a food item, comprising:
a cooking tube having a pocket for holding a food item and a spacer member; and
at least one spacer member disposed within the pocket for heat transfer engagement with a food item disposed in the pocket.

17. An apparatus for use in cooking a food item, comprising:
at least one spacer member;
a hollow tube having a longitudinal end portion for receiving a food item and the at least one spacer member within the interior of the hollow tube;
at least one lid member removably attached to the longitudinal end portion;
the at least one spacer member each including two planar outer plates and means for keeping the outer plates a fixed distance apart;
the at least spacer member and the transverse cross-section of the hollow tube being substantially circular;
the at least one spacer member is adapted to snugly fit into the hollow tube; and wherein the wall of the hollow tube is intersected by at least one aperture,
the at least one aperture having a dimension whereby the food item and the at least one spacer member cannot extend outside the interior of the hollow tube through the aperture;
the outer plates are intersected by at least one aperture; and the lids are intersected by at least one aperture.

18. The apparatus as set forth in claim 1 further comprising means coupled to the hollow tube for supporting the tube at an elevated position relative to a heat source.

19. The apparatus as set forth in claim 1 further comprising a cooking attachment comprising a second spacer member and a tube extending perpendicular from the second spacer member, whereby an annular space is formed within the hollow tube when the cooking attachment is received in the hollow tube.

20. An apparatus for use in cooking a plurality of food items, comprising:
a cooking tube having a pocket for receiving a plurality of food items and one or more spacer members;
one or more spacer members disposed within the pocket for heat transfer engagement with a plurality of food items disposed in the pocket; and
means coupled to the cooking tube for supporting the tube at an elevated position relative to a heat source.
